(19) United States
(12) Patent Application Publication
(10) Pub. No.: US 2007/0107669 A1
(43) Pub. Date: May 17, 2007

(54) Leash charging system and method for same

(76) Inventors: Eric T. Eaton, Lake Worth, FL (US); Nona E. Gage, Sea Ranch Lakes, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/273,044

(22) Filed: Nov. 14, 2005

(51) Int. Cl. A01K 27/00

(52) U.S. Cl. 119/792

(57) ABSTRACT

The invention concerns a leash charging system (100) and method (300) for charging. The system can include a collar (110) that includes a rechargeable power supply (130) and an interface (132) and a leash (112) that also includes a rechargeable power supply (144) and an interface (146, 148) that detachably engages the interface of the collar. When the leash engages the collar, the rechargeable power supply of the leash can charge the rechargeable power supply of the collar.

### BACKGROUND OF THE INVENTION

1. Field of the Invention

The present invention concerns charging systems and more particularly, charging systems for pet accessories.

2. Description of the Related Art

In recent years, pet owners have increased their spending on animal-related products. As an example, some pet owners have purchased pet collars that perform various functions. In particular, some collars include radio frequency (RF) circuitry, which can allow the pet wearing the collar to be tracked. Also, certain signals may be transmitted to these collars, and when they are received, the collars can signal the animal wearing the collar to perform some act. For example, a sheep dog may be signaled to herd a flock of sheep or a cow may be signaled to inform it that food is now available. In addition, some collars include circuitry for applying a small electric shock to the animal to prevent it from moving outside a virtual boundary or fence. A number of collars also have lights that illuminate under certain circumstances.

Many of these collars use disposable batteries as a power supply. These batteries, however, drain rather quickly and must be replaced, which can lead to greater expenses for the animal owner. Some collars may contain rechargeable batteries that can be recharged through a charger. Unfortunately, the collar must be removed from the animal to enable the batteries to be recharged.

### SUMMARY OF THE INVENTION

The present invention concerns a leash charging system. The leash can include a collar that can include a rechargeable power supply and an interface and a leash that also can include a rechargeable power supply and an interface that can detachably engage the interface of the collar. When the leash engages the collar, the rechargeable power supply of the leash can charge the rechargeable power supply of the collar. As an example, the collar can be substantially circular in shape to enable the collar to be worn by an animal. As another example, the leash can further include a handle on an end opposite that of an end containing the interface.

In one arrangement, the collar can further include a visual indication component to indicate a charge status of the rechargeable power supply of the collar. As an example, the visual indication component can be a display or one or more light emitting diodes. In another arrangement, the collar may also include a supplemental charging unit. For example, the supplemental charging unit can be an interface that receives a receptacle-based charger, one or more solar cells or a motion conversion element. As another example, the rechargeable power supplies of the collar and the leash may be lithium-ion batteries. Further, the collar and the leash can both further include waterproof casings that house the interfaces and rechargeable power supplies of the collar and the leash.

The system may also include a pet comfort element having an electric coil. The interface of the collar can further include a corresponding electric coil, and the coil in the pet comfort element may selectively induce a charging current in the coil of the interface of the collar. In particular, the coil in the pet comfort element may induce the charging current in the coil of the collar when the collar is worn by a pet that rests on the pet comfort element. The leash may further include a second interface that can receive a receptacle-based charger. Additionally, the system can include a charging unit having a coil, and the leash can further include a corresponding coil. The coil may induce a charging current in the corresponding coil of the leash when the leash is engaged with the charging unit.

The present invention also concerns a charging system for a pet collar. The system can include a collar having a coil and a rechargeable power supply coupled to the coil and a pet comfort element having a coil. The coil in the pet comfort element can selectively induce a charging current in the coil of the collar when the collar is worn by a pet that rests on the pet comfort element.

The present invention also concerns a method for charging. The method can include the steps of coupling a leash having a rechargeable power supply to a pet collar having a rechargeable power supply and charging the rechargeable power supply of the collar with the rechargeable power supply of the leash when the leash is coupled to the collar.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a leash charging system in accordance with an embodiment of the inventive arrangements;

FIG. 2 illustrates an example of a block diagram of a collar, a leash and a pet comfort element in accordance with an embodiment of the inventive arrangements; and

FIG. 3 illustrates an example of a method for charging in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” and “engagement,” as used herein, are defined as connected, although not necessarily directly, and not necessarily mechanically. The term “module” can be defined as any combination of hardware and/or software to enable an appropriate function to be performed. A pet can be any animal that a human may exert at least some control over.

The terms “program,” “application,” and the like as used herein, are defined as a sequence of instructions designed for execution on a computer system. A program, computer program, or application may include a subroutine, a function, a procedure, an object method, an object implementation, an executable application, an applet, a servlet, a source code, an object code, a shared library/dynamic load library and/or other sequence of instructions designed for execution on a computer system. Where suitable, the term “application” may even refer to a hardware setting or component.

The present invention concerns a leash charging system. Briefly, in one arrangement, the system can include a collar that can have a rechargeable power supply and an interface and can also include a leash that can have a rechargeable power supply and an interface that may detachably engage the interface of the collar. When the leash engages the collar, the rechargeable power supply of the leash may charge the rechargeable power supply of the collar. As a result, the rechargeable power supply of the collar can receive charging current without removing it from the animal wearing it. Other arrangements for charging the rechargeable power supply of the collar and the leash will be presented below.

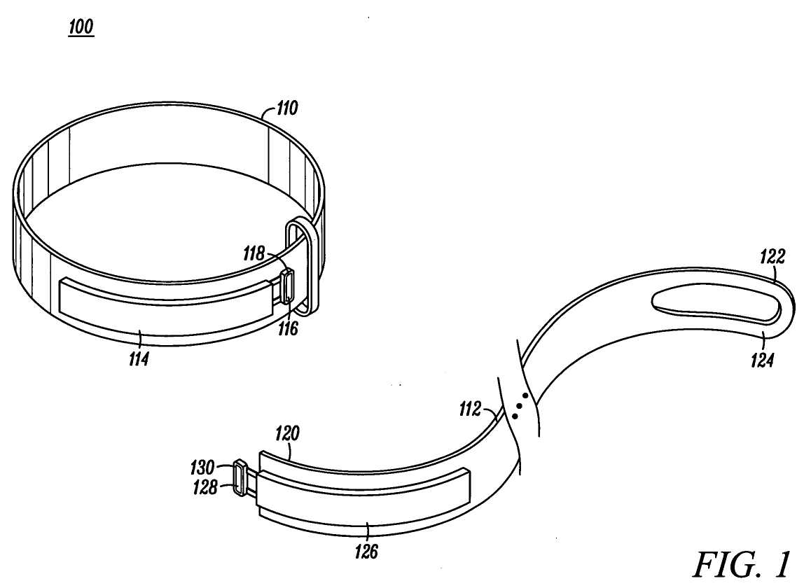

Referring to FIG. 1, a leash charging system 100 is shown. In one arrangement, the system 100 can include a collar 110 and a leash 112. As an example, the collar 110 can be substantially circular in shape and can be designed to be worn around a body part of an animal, such as the neck of a dog or cat. Of course, the invention is not so limited, as the collar 110 can be of any other suitable shape. In fact, the term collar can mean any device that is capable of being worn by an animal. Also, the term leash can include any device that can engage or couple to the collar and can provide the user of the leash with at least some control over the animal wearing the collar.

The collar 110 may include a casing 114 that can house several components, some of which will be presented below. This casing 114 can be weatherproof and can protect electrical components and circuitry from the elements. In one particular arrangement, the casing 114 can include a door 116 that can have a seal 118 that can be positioned along the edges of the door 116. The door 116 can be opened to provide access to an interface (not shown here), which, as will be explained below, can enable the collar 110 to be engaged with the leash 112. When closed, the seal 118 can engage the casing 114 to form a weatherproof barrier to protect the interface. The door 116 may include any suitable mechanism for enabling it to open and close and to snap shut and open with the casing 114. Those of skill in the art, however, will appreciate that there are other suitable ways to provide access to the casing 114 without sacrificing the integrity of the components inside.

The leash 112 can have a first end 120 and a second end 122, and a handle 124 may be provided at the second end 122. In addition, the leash 112 may also include a casing 126, which can be positioned at the first end 120. Like the casing 114, the casing 126 may be weatherproof for protecting electrical components and circuitry housed within and can have a door 128 for providing access to first and second interfaces (not shown). The first interface can detachably engage the interface of the collar.

Further, the door 128 can have a seal 130 that can enable the door to form a weatherproof barrier with the casing 126 when the door 128 is closed. Similar to the door 116, the door 128 can include any suitable structure for enabling it to open and close and to snap shut and open with the casing 126. Again, there are other suitable ways to provide access to the casing 126 without putting the components within the casing 126 at risk from weather-related damage.

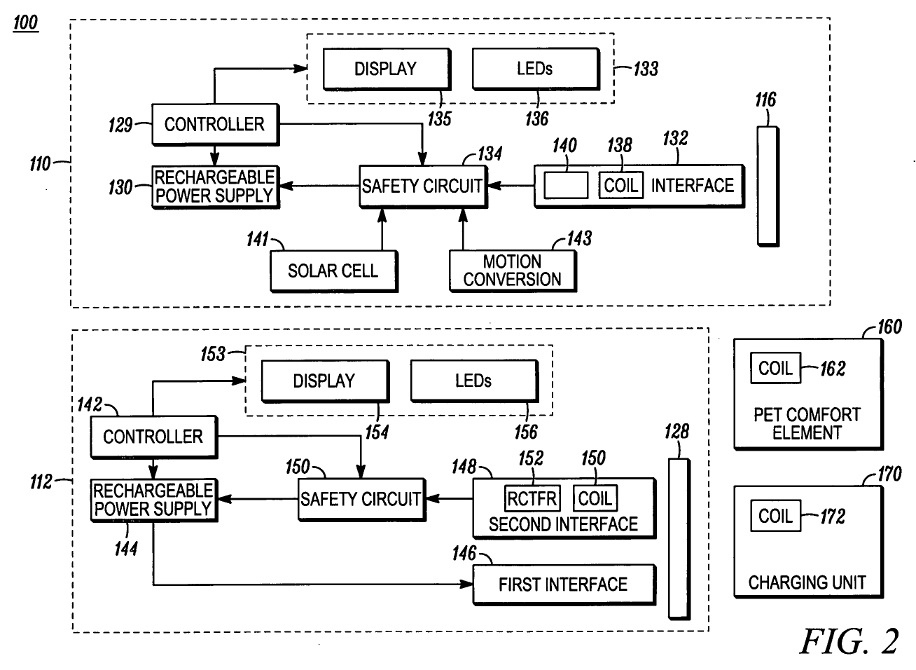

Referring to FIG. 2, a block diagram showing an example of the collar 110 and the leash 112 is shown. In one arrangement, the collar 110 can include a controller or processor 129, a rechargeable power supply 130, an interface 132 and a safety circuit 134. As an example, the rechargeable power supply 130 can be a lithium-ion battery or any other suitable type of rechargeable battery. As shown, the controller 129 can be coupled to the rechargeable power supply 130 and the safety circuit 134, and the interface 132 can be coupled to the supply 130 through the safety circuit 134. The interface 132 can include a suitable number of contacts (not shown) for receiving various types of signals, including charging current and/or data signals.

As an option, the collar 110 may also have a visual indication component 133, which may be a display 135 or one or more light emitting diodes (LED) 136, both of which may be coupled to the controller 129. The visual indication component 133 can provide an indication as to the charging status of the rechargeable power supply 130. For example, the display 135 and/or the LEDs 136 can display this information. The display 135 may also display other suitable types of information, such as the animal owner's name, address or other contact data. As another option, the interface 132 may include a coil 138 and a rectifier 140.

In another arrangement, the collar 110 may include a supplemental charging unit, such as one or more solar cells 141 and/or one or more motion conversion devices 143 for providing supplemental power to the rechargeable power supply 130 or any other suitable component. As an example, the motion conversion device 143 can include an oscillating weight or rotor, which, as is known in the art, can allow the motion conversion device 143 to generate kinetic energy. Also, the interface 132 can be designed to accept a conventional, receptacle-based charger. Those of skill in the art will appreciate that at least a portion of each of the above-recited components can be contained within the casing 126. Further, the door 116 can be opened to provide access to the interface 132.

The leash 112 can include a controller or processor 142, a rechargeable power supply 144, a first interface 146, a second interface 148 and a safety circuit 150. The rechargeable power supply 144 can be, for example, a lithium-ion battery or some other suitable type of rechargeable type of battery. In one embodiment of the invention, the controller 142 can be coupled to the power supply 144 and the safety circuit 150, and the first interface 146 and the second interface 148 can be coupled to the power supply 144 (the second interface 148 through the safety circuit 150).

The first interface 146 and second interface 148 can include contacts (not shown) for receiving or transmitting charging current and/or various data signals. Also, the first interface 146 of the leash 112 and the interface 132 of the collar 110 can both include suitable structure for detachably engaging one another. As an example, when engaged, a portion of the first interface 146 can fit within the interface 132 of the collar 110 and the contacts of both interfaces 132, 146 can touch one another.

The second interface 148 of the leash 112 may also include contacts (not shown) for receiving data and/or electrical signals from any suitable component. As an example, the second interface 148 can be coupled to a receptacle-based charging unit (not shown) that can be plugged into a conventional 110 volt wall outlet. As another example, the second interface 148 can include a coil 150 and a rectifier 152. The system 100 can also include a charging unit 170 having a coil 172. As will be explained below, the coil 172 can induce a charging current in the coil 150 of the second interface 148 of the leash 112.

The door 128 can be opened to provide access to either one of the first interface 146 and the second interface 148. It is understood that the first interface 146 and the second interface 148 may be separate units having separate electrical contacts or a single unit sharing electrical contacts that is capable of receiving either the interface 132 of the collar 110 or a charging unit for charging the power supply 144 of the leash 112.

Like the collar 110, the leash 112 may also include a visual indication component 153 for providing an indication as to the charging status of the rechargeable power supply 144, which can be a display 154 or one or more LEDs 156. At least a portion of each of the above-described components can be contained within the casing 126 of the leash 112 (see FIG. 1).

In one particular arrangement, the system 100 may also include a pet comfort element 160. The pet comfort element 160 can be, for example, a bed or some other component on which a pet may rest that is capable of having embedded electronics. As an example, a coil 162 can be embedded within the pet comfort element 160. As those of skill in the art will appreciate, the element 160 can include suitable electrical components, circuitry and software for providing a time-varying signal, such as an AC current, in the coil 162.

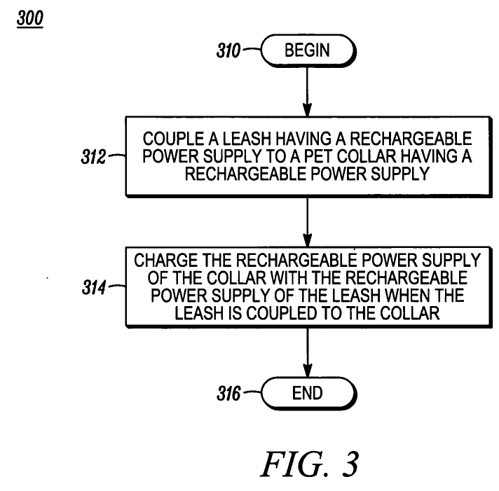

Referring to FIG. 3, a method 300 for charging is shown. When describing the method 300, reference may be made to FIGS. 1 and 2, although it must be noted that the method 300 can be practiced in any other suitable system or device. Moreover, the steps of the method 300 are not limited to the particular order in which they are presented in FIG. 3. The inventive method can also have a greater number of steps or a fewer number of steps than those shown in FIG. 3.

At step 310, the method can begin. At step 312, a leash having a rechargeable power supply can be coupled to a pet collar having a rechargeable power supply. In addition, at step 314, the rechargeable power supply of the collar can be charged with the rechargeable power supply of the leash when the leash is coupled to the collar. At step 316, the method 300 can end.

For example, referring to FIGS. 1 and 2, a user can charge the rechargeable power supply 144 of the leash 112. In particular, the user may open the door 128 to gain access to the second interface 148. The user can then couple a receptacle-based charging unit (not shown) to the second interface 148, which can, as a result, provide charging current to the rechargeable power supply 144. The controller 142 can monitor the charging process and can control the flow of charging current to the power supply 144 through the safety circuit 150.

As another example, the second interface 148 can be coupled to the charging unit 170 having the coil 172, and the coil 172 in the charging unit can generate a current in the coil 150 of the second interface 148. The rectifier 152 can convert the charging current to DC, which can then be used to charge the rechargeable power supply 144. In either arrangement, controller 142 can signal the display 154 or the LEDs 156 to provide an indication as to the status of the charge on the power supply 144. Any suitable structure can be employed to secure the second interface 148 to the charging unit 170 sufficiently to cause the charging current to be induced in the coil 150.

Once the power supply 144 is charged to an acceptable level, the user may remove the leash 112 from the charging unit and can couple the leash 112 to the collar 110. In particular, the user can open the door 116 of the collar 110 and the door 128 of the leash 112 and can couple or engage the interface 132 of the collar 110 to the first interface 146 of the leash 112. At this point, the power supply 144 of the leash 112 can provide charging current to the power supply 130 of the collar 110. As an example, the collar 110 may be worn by an animal, such as a dog, and while the animal is being walked by the user, the power supply 130 of the collar 110 can be conveniently charged.

The controller 129 of the collar 110 can monitor the power supply 130 and can control the flow of charging current to the power supply 130 through the safety circuit 134. The controller 129 can also signal the display 135 and/or the LEDs 136 to provide an indication as to the status of the charge on the power supply 130 or some other information. Depending on its charge, the power supply 130 may provide power to any suitable number of components of the collar 110, such as other lights or displays, transceivers, controllers or processors, etc. The solar cells 141 and/or the motion conversion devices 143 may also provide supplemental power to the power supply 130 or any other component of the collar 110.

When the user is finished with the leash 112, the user can disengage or decouple the interface 132 of the collar 110 from the first interface 146 of the leash 112. In addition, the user can securely close the doors 116 and 128 to protect the integrity of the casings 114 and 126.

The pet comfort element 160 may also provide charging current to the power supply 130 of the collar 110. For example, an animal wearing the collar 110 may rest on the pet comfort element 160, and the coil 162 of the element 160 can induce a current in the coil 138 of the interface 132, which the rectifier 140 can convert to DC. This current can be used to charge the power supply 130. This charging process can be similar to the process described above in that the controller 129 can monitor and control the flow of current to the power supply 130. In either of the examples described above, the power supply 130 of the collar 110 can be charged without removing it from the animal wearing it.

It must also be noted that the leash 112 and/or collar 110 may include suitable structure to enable the leash 112 to engage or couple the collar 110 in a conventional manner, such as hooks, clips, hook and loop type fasteners, etc. This conventional engagement can supplement the interface 132 engaging the first interface 146 or can be used in lieu thereof.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A leash charging system, comprising:
a collar that includes a rechargeable power supply and an interface; and
a leash that also includes a rechargeable power supply and an interface that detachably engages the interface of the collar and when the leash engages the collar, the rechargeable power supply of the leash charges the rechargeable power supply of the collar.

2. The system according to claim 1, wherein the collar is substantially circular in shape to enable the collar to be worn by an animal.

3. The system according to claim 1, wherein the leash further includes a handle on an end opposite that of an end containing the interface.

4. The system according to claim 1, wherein the collar further includes a visual indication component to indicate a charge status of the rechargeable power supply of the collar.

5. The system according to claim 4, wherein the visual indication component is a display or one or more light emitting diodes.

6. The system according to claim 1, wherein the collar further includes a supplemental charging unit.

7. The system according to claim 6, wherein the supplemental charging unit is an interface that receives a receptacle-based charger, one or more solar cells or a motion conversion element.

8. The system according to claim 1, wherein the rechargeable power supplies of the collar and the leash are lithium-ion batteries.

9. The system according to claim 1, wherein the collar and the leash both further include waterproof casings that house the interfaces and rechargeable power supplies of the collar and the leash.

10. The system according to claim 1, further comprising a pet comfort element having an electric coil, wherein the interface of the collar further includes a corresponding electric coil and wherein the coil in the pet comfort element selectively induces a charging current in the coil of the interface of the collar.

11. The system according to claim 10, wherein the coil in the pet comfort element induces the charging current in the coil of the collar when the collar is worn by a pet that rests on the pet comfort element.

12. The system according to claim 1, wherein the leash further includes a second interface that receives a receptacle-based charger.

13. The system according to claim 1, further comprising a charging unit having a coil, wherein the leash further includes a corresponding coil and the coil induces a charging current in the corresponding coil of the leash when the leash is engaged with the charging unit.

14. A leash, comprising:
a rechargeable power supply; and
an interface that is electrically coupled to the rechargeable power supply and that detachably engages an interface of a collar and when the leash engages the collar, the rechargeable power supply of the leash charges a rechargeable power supply of the collar.

15. The leash according to claim 14, wherein the leash further includes a waterproof casing that houses the interface and the rechargeable power supply of the leash.

16. The leash according to claim 14, wherein the leash further includes a coil and a coil in a charging unit induces a charging current in the coil of the leash when the leash is engaged with the charging unit.

17. A charging system for a pet collar, comprising:
a collar having a coil and a rechargeable power supply coupled to the coil; and
a pet comfort element having a coil, wherein the coil in the pet comfort element selectively induces a charging current in the coil of the collar when the collar is worn by a pet that rests on the pet comfort element.

18. A method for charging, comprising:
coupling a leash having a rechargeable power supply to a pet collar having a rechargeable power supply; and
charging the rechargeable power supply of the collar with the rechargeable power supply of the leash when the leash is coupled to the collar.
